(19) United States
(12) Patent Application Publication
(10) Pub. No.: US 2025/0285227 A1
(43) Pub. Date: Sep. 11, 2025

(54) SYSTEM AND METHOD FOR IMPROVING IMAGE QUALITY DURING INSPECTION

(71) Applicant: ASML Netherlands B.V., Veldhoven (NL)

(72) Inventor: Maikel Robert GOOSEN, Eindhoven (NL)

(73) Assignee: ASML Netherlands B.V., Veldhoven (NL)

(21) Appl. No.: 18/859,954

(22) PCT Filed: Mar. 28, 2023
(86) PCT No.: PCT/EP2023/057947

§ 371 Date: Oct. 24, 2024

(30) Foreign Application Priority Data
Apr. 27, 2022 (EP) 22170392.9

(51) Int. Cl. G06T 5/50; G06T 5/73; G06T 7/00

(52) U.S. Cl. CPC G06T 5/50; G06T 5/73; G06T 7/0004; G06T 2207/10148; G06T 2207/30148; G06T 2207/30168

(57) ABSTRACT

Systems, apparatuses, and methods for improving image quality. In some embodiments, a method may include obtaining a plurality of images of an area of a sample; determining via a phase diversity analysis: ma plurality of focus-related values, wherein each focus-related value of the plurality of focus-related values is associated with each image of the plurality of images; a maximum likelihood estimate of the plurality of images; and generating a focus-corrected image of the area based on the determined plurality of focus-related values and the determined maximum likelihood estimate.

### CROSS-REFERENCE TO RELATED APPLICATIONS

This application claims priority of EP application Ser. No. 22/170,392.9 which was filed on 27 Apr. 2022 and which is incorporated herein in its entirety by reference.

### FIELD

The description herein relates to the field of inspection systems, and more particularly to systems for improving image quality during inspection.

### BACKGROUND

In manufacturing processes of integrated circuits (ICs), unfinished or finished circuit components are inspected to ensure that they are manufactured according to design and are free of defects. An inspection system utilizing an optical microscope typically has resolution down to a few hundred nanometers; and the resolution is limited by the wavelength of light. As the physical sizes of IC components continue to reduce down to sub-100 or even sub-10 nanometers, inspection systems capable of higher resolution than those utilizing optical microscopes are needed.

A charged particle (e.g., electron) beam microscope, such as a scanning electron microscope (SEM) or a transmission electron microscope (TEM), capable of resolution down to less than a nanometer, serves as a practicable tool for inspecting IC components having a feature size that is sub-100 nanometers. With a SEM, electrons of a single primary electron beam, or electrons of a plurality of primary electron beams, can be focused at locations of interest of a wafer under inspection. The primary electrons interact with the wafer and may be backscattered or may cause the wafer to emit secondary electrons. The intensity of the electron beams comprising the backscattered electrons and the secondary electrons may vary based on the properties of the internal and external structures of the wafer, and thereby may indicate whether the wafer has defects.

### SUMMARY

Embodiments of the present disclosure provide apparatuses, systems, and methods for improving image quality. In some embodiments, systems, methods, and non-transitory computer readable mediums may include steps of obtaining a plurality of images of an area of a sample; determining via a phase diversity analysis: a plurality of focus-related values, wherein each focus-related value of the plurality of focus-related values is associated with each image of the plurality of images; a maximum likelihood estimate of the plurality of images; and generating a focus-corrected image of the area based on the determined plurality of focus-related values and the determined maximum likelihood estimate.

In some embodiments, systems, methods, and non-transitory computer readable mediums may include steps of obtaining a plurality of images of an area of a sample; determining via a phase diversity analysis: a plurality of focus-related values, wherein each focus-related value of the plurality of focus-related values is associated with each image of the plurality of images; a maximum likelihood estimate of the plurality of images; and generating a focus-adjusted image of the area based on the determined plurality of focus-related values and the determined maximum likelihood estimate.

In some embodiments, systems, methods, and non-transitory computer readable mediums may include steps of obtaining a plurality of images of an area in a field of view of a sample, wherein a first image of the plurality of images has a first focus-related value and a second image of the plurality of images has a second focus-related value that is different from the first focus-related value; and generating a focus-adjusted image of the area in the field of view using the first and second images.

### BRIEF DESCRIPTION OF THE DRAWINGS

FIG. 1 is a schematic diagram illustrating an exemplary electron beam inspection (EBI) system, consistent with embodiments of the present disclosure.

FIG. 2 is a schematic diagram illustrating an exemplary multi-beam system that is part of the exemplary charged particle beam inspection system of FIG. 1, consistent with embodiments of the present disclosure.

FIG. 3 is a schematic diagram of an exemplary system for improving image quality, consistent with embodiments of the present disclosure.

FIG. 4 is a schematic diagram illustrating an exemplary sample and an image generation schematic, consistent with embodiments of the present disclosure.

FIG. 5 is a flowchart illustrating an exemplary process of improving image quality, consistent with embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the disclosure. Instead, they are merely examples of apparatuses and methods consistent with aspects related to the subject matter recited in the appended claims. For example, although some embodiments are described in the context of utilizing electron beams, the disclosure is not so limited. Other types of charged particle beams may be similarly applied. Furthermore, other imaging systems may be used, such as optical imaging, photodetection, x-ray detection, extreme ultraviolet inspection, deep ultraviolet inspection, or the like, in which they generate corresponding types of images.

Electronic devices are constructed of circuits formed on a piece of silicon called a substrate. Many circuits may be formed together on the same piece of silicon and are called integrated circuits or ICs. The size of these circuits has decreased dramatically so that many more of them can fit on the substrate. For example, an IC chip in a smart phone can be as small as a thumbnail and yet may include over 2 billion transistors, the size of each transistor being less than 1/1000th the size of a human hair.

Making these extremely small ICs is a complex, time-consuming, and expensive process, often involving hundreds of individual steps. Errors in even one step have the potential to result in defects in the finished IC rendering it useless. Thus, one goal of the manufacturing process is to avoid such defects to maximize the number of functional ICs made in the process, that is, to improve the overall yield of the process.

One component of improving yield is monitoring the chip making process to ensure that it is producing a sufficient number of functional integrated circuits. One way to monitor the process is to inspect the chip circuit structures at various stages of their formation. Inspection may be carried out using a scanning electron microscope (SEM). A SEM can be used to image these extremely small structures, in effect, taking a “picture” of the structures of the wafer. The image can be used to determine if the structure was formed properly and also if it was formed at the proper location. If the structure is defective, then the process can be adjusted so the defect is less likely to recur. Defects may be generated during various stages of semiconductor processing. For the reason stated above, it is important to find defects accurately and efficiently as early as possible.

The working principle of a SEM is similar to a camera. A camera takes a picture by receiving and recording brightness and colors of light reflected or emitted from people or objects. A SEM takes a “picture” by receiving and recording energies or quantities of electrons reflected or emitted from the structures. Before taking such a “picture,” an electron beam may be provided onto the structures, and when the electrons are reflected or emitted (“exiting”) from the structures, a detector of the SEM may receive and record the energies or quantities of those electrons to generate an image. To take such a “picture,” some SEMs use a single electron beam (referred to as a “single-beam SEM”), while some SEMs use multiple electron beams (referred to as a “multi-beam SEM”) to take multiple “pictures” of the wafer. By using multiple electron beams, the SEM may provide more electron beams onto the structures for obtaining these multiple “pictures,” resulting in more electrons exiting from the structures. Accordingly, the detector may receive more exiting electrons simultaneously, and generate images of the structures of the wafer with a higher efficiency and a faster speed.

During inspection, it is advantageous to generate images (e.g., SEM images, optical images, x-ray images, photon images, etc.) having higher resolutions or sharpness so that the features (e.g., a contact, a metal line, a gate, etc.) on a sample in the images accurately represent the actual sample. In order to generate higher resolution or sharpness images, images of the features on the sample need to be in focus. Aberrations, such as a defocused electron beam, may result in blurred, low-quality images. To facilitate obtaining a high quality focus, the settings of an inspection system (e.g., the voltage or strength of an objective lens) may be adjusted to adjust the probe size of an electron beam.

In typical inspection systems, a focus measurement of the inspection system is performed to facilitate generating high quality images. A typical focus measurement involves obtaining images of a sample in an area outside of a Field of View (FOV). For example, the FOV may include areas of the sample to be inspected while the typical focus measurement obtains images of the sample outside of the areas to be inspected. The typical focus measurement involves obtaining a plurality of images of a sample outside of the FOV at different defocus values. For example, the objective lens may be adjusted (e.g., using different voltage values or different current values) before each image of the area outside of the FOV is obtained so that each image of the focus measurement has a different defocus value. The inspection setting (e.g., the voltage value of the objective lens) that corresponds to the highest resolution image or the highest sharpness image (e.g., determined by a key performance indicator (KPI) of resolution or sharpness) of the area outside of the FOV is used to obtain images of the sample within the FOV (e.g., one or more areas within the FOV, the entire FOV, etc.) during inspection.

In typical inspection systems, a plurality of images of the sample in the FOV are obtained using the inspection setting that corresponds to the highest resolution image or the highest sharpness image of the area outside of the FOV during the focus measurement. An average of the plurality of images (e.g., also referred to as a plurality of frames) of the sample within the FOV is determined to generate an inspection image of the sample in the FOV.

Typical focus measurements and inspections, however, suffer from constraints. An example of a constraint with typical inspections is that inspection throughput is low because multiple images are obtained for the focus measurement outside of the FOV and multiple images are obtained for the inspection measurement within the FOV. Another example of a constraint with typical inspections is that focus deviations may occur over a sample (e.g., the field of curvature may vary across the FOV), thereby reducing the accuracy and the quality of the generated inspection image since a focus measurement of an area outside of the FOV may not be applicable to an inspection image obtained from an area inside the FOV. Yet another example of a constraint with typical inspections is that noise within the obtained images may reduce the throughput of the generated inspection images.

Some of the disclosed embodiments provide systems and methods that address some or all of these disadvantages by improving image quality during inspection. The disclosed embodiments may use a phase diversity analysis to determine focus-related values (e.g., defocus values) and a maximum likelihood estimate of images of a sample within a FOV, thereby enabling generation of a focus-adjusted (e.g., focus-corrected) image of the sample.

Relative dimensions of components in drawings may be exaggerated for clarity. Within the following description of drawings, the same or like reference numbers refer to the same or like components or entities, and only the differences with respect to the individual embodiments are described.

As used herein, unless specifically stated otherwise, the term “or” encompasses all possible combinations, except where infeasible. For example, if it is stated that a component may include A or B, then, unless specifically stated otherwise or infeasible, the component may include A, or B, or A and B. As a second example, if it is stated that a component may include A, B, or C, then, unless specifically stated otherwise or infeasible, the component may include A, or B, or C, or A and B, or A and C, or B and C, or A and B and C.

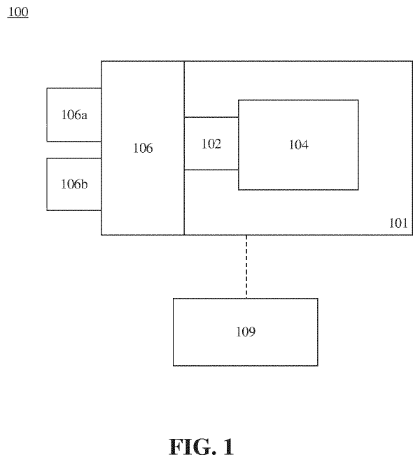

FIG. 1 illustrates an exemplary electron beam inspection (EBI) system 100 consistent with embodiments of the present disclosure. EBI system 100 may be used for imaging. As shown in FIG. 1, EBI system 100 includes a main chamber 101, a load/lock chamber 102, an electron beam tool 104, and an equipment front end module (EFEM) 106. Electron beam tool 104 is located within main chamber 101. EFEM 106 includes a first loading port 106a and a second loading port 106b. EFEM 106 may include additional loading port(s). First loading port 106a and second loading port 106b receive wafer front opening unified pods (FOUPs) that contain wafers (e.g., semiconductor wafers or wafers made of other material(s)) or samples to be inspected (wafers and samples may be used interchangeably). A “lot” is a plurality of wafers that may be loaded for processing as a batch.

One or more robotic arms (not shown) in EFEM 106 may transport the wafers to load/lock chamber 102. Load/lock chamber 102 is connected to a load/lock vacuum pump system (not shown) which removes gas molecules in load/lock chamber 102 to reach a first pressure below the atmospheric pressure. After reaching the first pressure, one or more robotic arms (not shown) may transport the wafer from load/lock chamber 102 to main chamber 101. Main chamber 101 is connected to a main chamber vacuum pump system (not shown) which removes gas molecules in main chamber 101 to reach a second pressure below the first pressure. After reaching the second pressure, the wafer is subject to inspection by electron beam tool 104. Electron beam tool 104 may be a single-beam system or a multi-beam system.

A controller 109 is electronically connected to electron beam tool 104. Controller 109 may be a computer configured to execute various controls of EBI system 100. While controller 109 is shown in FIG. 1 as being outside of the structure that includes main chamber 101, load/lock chamber 102, and EFEM 106, it is appreciated that controller 109 may be a part of the structure.

In some embodiments, controller 109 may include one or more processors (not shown). A processor may be a generic or specific electronic device capable of manipulating or processing information. For example, the processor may include any combination of any number of a central processing unit (or “CPU”), a graphics processing unit (or “GPU”), an optical processor, a programmable logic controllers, a microcontroller, a microprocessor, a digital signal processor, an intellectual property (IP) core, a Programmable Logic Array (PLA), a Programmable Array Logic (PAL), a Generic Array Logic (GAL), a Complex Programmable Logic Device (CPLD), a Field-Programmable Gate Array (FPGA), a System On Chip (SoC), an Application-Specific Integrated Circuit (ASIC), and any type circuit capable of data processing. The processor may also be a virtual processor that includes one or more processors distributed across multiple machines or devices coupled via a network.

In some embodiments, controller 109 may further include one or more memories (not shown). A memory may be a generic or specific electronic device capable of storing codes and data accessible by the processor (e.g., via a bus). For example, the memory may include any combination of any number of a random-access memory (RAM), a read-only memory (ROM), an optical disc, a magnetic disk, a hard drive, a solid-state drive, a flash drive, a security digital (SD) card, a memory stick, a compact flash (CF) card, or any type of storage device. The codes may include an operating system (OS) and one or more application programs (or “apps”) for specific tasks. The memory may also be a virtual memory that includes one or more memories distributed across multiple machines or devices coupled via a network.

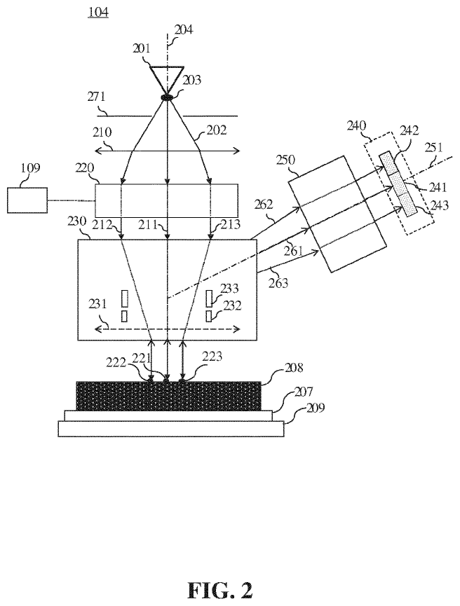

Reference is now made to FIG. 2, which is a schematic diagram illustrating an exemplary electron beam tool 104 including a multi-beam inspection tool that is part of the EBI system 100 of FIG. 1, consistent with embodiments of the present disclosure. In some embodiments, electron beam tool 104 may be operated as a single-beam inspection tool that is part of EBI system 100 of FIG. 1. Multi-beam electron beam tool 104 (also referred to herein as apparatus 104) comprises an electron source 201, a Coulomb aperture plate (or “gun aperture plate”) 271, a condenser lens 210, a source conversion unit 220, a primary projection system 230, a motorized stage 209, and a sample holder 207 supported by motorized stage 209 to hold a sample 208 (e.g., a wafer or a photomask) to be inspected. Multi-beam electron beam tool 104 may further comprise a secondary projection system 250 and an electron detection device 240. Primary projection system 230 may comprise an objective lens 231. Electron detection device 240 may comprise a plurality of detection elements 241, 242, and 243. A beam separator 233 and a deflection scanning unit 232 may be positioned inside primary projection system 230.

Electron source 201, Coulomb aperture plate 271, condenser lens 210, source conversion unit 220, beam separator 233, deflection scanning unit 232, and primary projection system 230 may be aligned with a primary optical axis 204 of apparatus 104. Secondary projection system 250 and electron detection device 240 may be aligned with a secondary optical axis 251 of apparatus 104.

Electron source 201 may comprise a cathode (not shown) and an extractor or anode (not shown), in which, during operation, electron source 201 is configured to emit primary electrons from the cathode and the primary electrons are extracted or accelerated by the extractor and/or the anode to form a primary electron beam 202 that form a primary beam crossover (virtual or real) 203. Primary electron beam 202 may be visualized as being emitted from primary beam crossover 203.

Source conversion unit 220 may comprise an image-forming element array (not shown), an aberration compensator array (not shown), a beam-limit aperture array (not shown), and a pre-bending micro-deflector array (not shown). In some embodiments, the pre-bending micro-deflector array deflects a plurality of primary beamlets 211, 212, 213 of primary electron beam 202 to normally enter the beam-limit aperture array, the image-forming element array, and an aberration compensator array. In some embodiments, apparatus 104 may be operated as a single-beam system such that a single primary beamlet is generated. In some embodiments, condenser lens 210 is designed to focus primary electron beam 202 to become a parallel beam and be normally incident onto source conversion unit 220. The image-forming element array may comprise a plurality of micro-deflectors or micro-lenses to influence the plurality of primary beamlets 211, 212, 213 of primary electron beam 202 and to form a plurality of parallel images (virtual or real) of primary beam crossover 203, one for each of the primary beamlets 211, 212, and 213. In some embodiments, the aberration compensator array may comprise a field curvature compensator array (not shown) and an astigmatism compensator array (not shown). The field curvature compensator array may comprise a plurality of micro-lenses to compensate field curvature aberrations of the primary beamlets 211, 212, and 213. The astigmatism compensator array may comprise a plurality of micro-stigmators to compensate astigmatism aberrations of the primary beamlets 211, 212, and 213. The beam-limit aperture array may be configured to limit diameters of individual primary beamlets 211, 212, and 213. FIG. 2 shows three primary beamlets 211, 212, and 213 as an example, and it is appreciated that source conversion unit 220 may be configured to form any number of primary beamlets. Controller 109 may be connected to various parts of EBI system 100 of FIG. 1, such as source conversion unit 220, electron detection device 240, primary projection system 230, or motorized stage 209. In some embodiments, as explained in further details below, controller 109 may perform various image and signal processing functions. Controller 109 may also generate various control signals to govern operations of the charged particle beam inspection system.

Condenser lens 210 is configured to focus primary electron beam 202. Condenser lens 210 may further be configured to adjust electric currents of primary beamlets 211, 212, and 213 downstream of source conversion unit 220 by varying the focusing power of condenser lens 210. Alternatively, the electric currents may be changed by altering the radial sizes of beam-limit apertures within the beam-limit aperture array corresponding to the individual primary beamlets. The electric currents may be changed by both altering the radial sizes of beam-limit apertures and the focusing power of condenser lens 210. Condenser lens 210 may be an adjustable condenser lens that may be configured so that the position of its first principle plane is movable. The adjustable condenser lens may be configured to be magnetic, which may result in off-axis beamlets 212 and 213 illuminating source conversion unit 220 with rotation angles. The rotation angles change with the focusing power or the position of the first principal plane of the adjustable condenser lens. Condenser lens 210 may be an anti-rotation condenser lens that may be configured to keep the rotation angles unchanged while the focusing power of condenser lens 210 is changed. In some embodiments, condenser lens 210 may be an adjustable anti-rotation condenser lens, in which the rotation angles do not change when its focusing power and the position of its first principal plane are varied.

Objective lens 231 may be configured to focus beamlets 211, 212, and 213 onto a sample 208 for inspection and may form, in the current embodiments, three probe spots 221, 222, and 223 on the surface of sample 208. Coulomb aperture plate 271, in operation, is configured to block off peripheral electrons of primary electron beam 202 to reduce Coulomb effect. The Coulomb effect may enlarge the size of each of probe spots 221, 222, and 223 of primary beamlets 211, 212, 213, and therefore deteriorate inspection resolution.

Beam separator 233 may, for example, be a Wien filter comprising an electrostatic deflector generating an electrostatic dipole field and a magnetic dipole field (not shown in FIG. 2). In operation, beam separator 233 may be configured to exert an electrostatic force by electrostatic dipole field on individual electrons of primary beamlets 211, 212, and 213. The electrostatic force is equal in magnitude but opposite in direction to the magnetic force exerted by magnetic dipole field of beam separator 233 on the individual electrons. Primary beamlets 211, 212, and 213 may therefore pass at least substantially straight through beam separator 233 with at least substantially zero deflection angles.

Deflection scanning unit 232, in operation, is configured to deflect primary beamlets 211, 212, and 213 to scan probe spots 221, 222, and 223 across individual scanning areas in a section of the surface of sample 208. In response to incidence of primary beamlets 211, 212, and 213 or probe spots 221, 222, and 223 on sample 208, electrons emerge from sample 208 and generate three secondary electron beams 261, 262, and 263. Each of secondary electron beams 261, 262, and 263 typically comprise secondary electrons (having electron energy ≤50 eV) and backscattered electrons (having electron energy between 50 eV and the landing energy of primary beamlets 211, 212, and 213). Beam separator 233 is configured to deflect secondary electron beams 261, 262, and 263 towards secondary projection system 250. Secondary projection system 250 subsequently focuses secondary electron beams 261, 262, and 263 onto detection elements 241, 242, and 243 of electron detection device 240. Detection elements 241, 242, and 243 are arranged to detect corresponding secondary electron beams 261, 262, and 263 and generate corresponding signals which are sent to controller 109 or a signal processing system (not shown), e.g., to construct images of the corresponding scanned areas of sample 208.

In some embodiments, detection elements 241, 242, and 243 detect corresponding secondary electron beams 261, 262, and 263, respectively, and generate corresponding intensity signal outputs (not shown) to an image processing system (e.g., controller 109). In some embodiments, each detection element 241, 242, and 243 may comprise one or more pixels. The intensity signal output of a detection element may be a sum of signals generated by all the pixels within the detection element.

In some embodiments, controller 109 may comprise image processing system that includes an image acquirer (not shown), a storage (not shown). The image acquirer may comprise one or more processors. For example, the image acquirer may comprise a computer, server, mainframe host, terminals, personal computer, any kind of mobile computing devices, and the like, or a combination thereof. The image acquirer may be communicatively coupled to electron detection device 240 of apparatus 104 through a medium such as an electrical conductor, optical fiber cable, portable storage media, IR, Bluetooth, internet, wireless network, wireless radio, among others, or a combination thereof. In some embodiments, the image acquirer may receive a signal from electron detection device 240 and may construct an image. The image acquirer may thus acquire images of sample 208. The image acquirer may also perform various post-processing functions, such as generating contours, superimposing indicators on an acquired image, and the like. The image acquirer may be configured to perform adjustments of brightness and contrast, etc. of acquired images. In some embodiments, the storage may be a storage medium such as a hard disk, flash drive, cloud storage, random access memory (RAM), other types of computer readable memory, and the like. The storage may be coupled with the image acquirer and may be used for saving scanned raw image data as original images, and post-processed images.

In some embodiments, the image acquirer may acquire one or more images of a sample based on an imaging signal received from electron detection device 240. An imaging signal may correspond to a scanning operation for conducting charged particle imaging. An acquired image may be a single image comprising a plurality of imaging areas. The single image may be stored in the storage. The single image may be an original image that may be divided into a plurality of regions. Each of the regions may comprise one imaging area containing a feature of sample 208. The acquired images may comprise multiple images of a single imaging area of sample 208 sampled multiple times over a time sequence. The multiple images may be stored in the storage. In some embodiments, controller 109 may be configured to perform image processing steps with the multiple images of the same location of sample 208.

In some embodiments, controller 109 may include measurement circuitries (e.g., analog-to-digital converters) to obtain a distribution of the detected secondary electrons. The electron distribution data collected during a detection time window, in combination with corresponding scan path data of each of primary beamlets 211, 212, and 213 incident on the wafer surface, can be used to reconstruct images of the wafer structures under inspection. The reconstructed images can be used to reveal various features of the internal or external structures of sample 208, and thereby can be used to reveal any defects that may exist in the wafer.

In some embodiments, controller 109 may control motorized stage 209 to move sample 208 during inspection of sample 208. In some embodiments, controller 109 may enable motorized stage 209 to move sample 208 in a direction continuously at a constant speed. In other embodiments, controller 109 may enable motorized stage 209 to change the speed of the movement of sample 208 overtime depending on the steps of scanning process.

Although FIG. 2 shows that apparatus 104 uses three primary electron beams, it is appreciated that apparatus 104 may use two or more number of primary electron beams. The present disclosure does not limit the number of primary electron beams used in apparatus 104. In some embodiments, apparatus 104 may be a SEM used for lithography. In some embodiments, electron beam tool 104 may be a single-beam system or a multi-beam system.

Compared with a single charged-particle beam imaging system (“single-beam system”), a multiple charged-particle beam imaging system (“multi-beam system”) may be designed to optimize throughput for different scan modes. Embodiments of this disclosure provide a multi-beam system with the capability of optimizing throughput for different scan modes by using beam arrays with different geometries. adapting to different throughputs and resolution requirements.

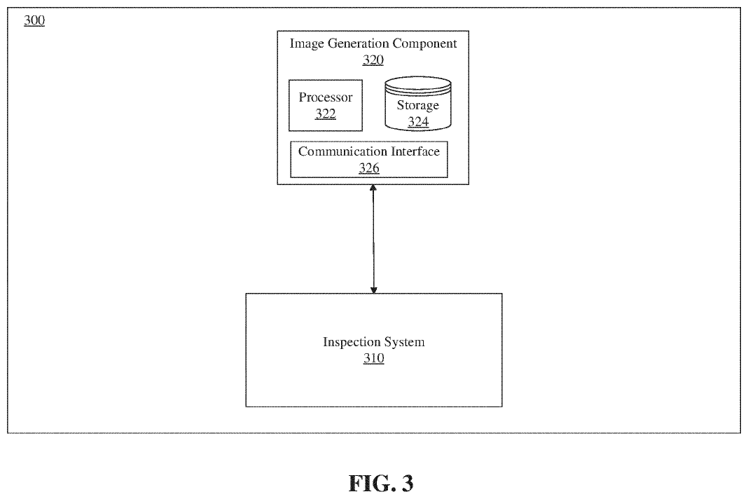

FIG. 3 is a schematic diagram of a system for improving image quality, consistent with embodiments of the present disclosure. System 300 may include an inspection system 310 and an image generation component 320. Inspection system 310 and image generation component 320 may be electrically coupled (directly or indirectly) to each other, either physically (e.g., by a cable) or remotely. Inspection system 310 may be the system described with respect to FIGS. 1 and 2, used to acquire images of a wafer (see, e.g., sample 208 of FIG. 2). In some embodiments, components of system 300 may be implemented as one or more servers (e.g., where each server includes its own processor). In some embodiments, components of system 300 may be implemented as software that may pull data from one or more databases of system 300. In some embodiments, system 300 may include one server or a plurality of servers. In some embodiments, system 300 may include one or more modules that are implemented by a controller (e.g., controller 109 of FIG. 1, controller 109 of FIG. 2).

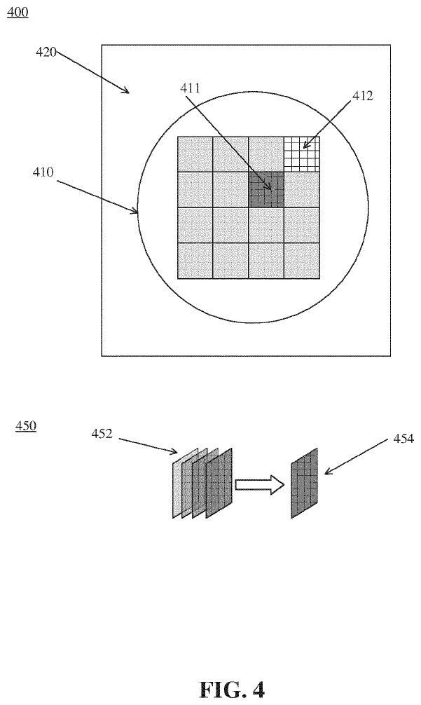

Inspection system 310 may obtain a plurality of images (e.g., images 452 of FIG. 4) of an area (e.g., areas 411 or 412 of FIG. 4) of a sample (e.g., sample 208 of FIG. 2 or sample 400 of FIG. 4). Each obtained image of the plurality of images may have a different focus-related value (e.g., defocus value) due to an adjustment of an inspection setting during image acquisition. For example, the adjusted inspection setting may be a strength of the objective lens (e.g., using different voltage values or different current values). In some embodiments, the objective lens (e.g., objective lens 231 of FIG. 2) may be adjusted before each image of an area of a FOV (e.g., FOV 410 of FIG. 4) is obtained such that each image has a different defocus value. In some embodiments, the adjusted inspection setting may be a range of strength of the objective lens (e.g., a range of voltage values). Each image of the plurality of images may be obtained from the same area of a sample in a FOV. Inspection system 310 may transmit data including the plurality of images of the area of the sample to image generation component 320.

Image generation component 320 may include one or more processors (e.g., represented as processor 322, which can have one or more corresponding accelerators) and a storage 324. Image generation component 320 may also include a communication interface 326 to receive from and send data to inspection system 310. In some embodiments, processor 322 may be configured to use a phase diversity analysis to determine a defocus value associated with each image of the plurality of images received from inspection system 310 and a maximum likelihood estimate of the plurality of images.

A phase diversity analysis involves using multiple images of the same area, where a phase diversity (e.g., an aberration, a defocused electron beam, etc.) may be introduced to the area before each image of the multiple images is obtained. For example, a phase diversity may be introduced to the area before each image is obtained by adjusting the strength of the objective lens before obtaining each image. By controlling the phase diversity that is introduced to the area, processor 322 may maximize an objective function and solve for the unknown variables (e.g., defocus value of an image).

A maximum likelihood estimate of the plurality of images may be obtained from the defocused images and their associated defocus values using phase diversity analysis. In some embodiments, the maximum likelihood estimate may be a final, focus-adjusted (e.g., focus-corrected) image of an area within the FOV. The maximum likelihood estimate may be obtained regardless of whether the defocus values correspond to the true unknown defocus value since the defocus distance between the images may be known. The phase diversity analysis allows for simultaneous determination of the maximum likelihood estimate as well as the true unknown defocus value. Image generation component 320 may advantageously use a phase diversity analysis with a non-iterative approach to maximize the objective function since it solves for a single unknown variable (e.g., defocus value of an image), thereby increasing throughput of inspection.

In some embodiments, other types of phase diversity may be used in the phase diversity analysis. For example, phase diversity types that may be used in addition to, or in place of, a defocus value include aperture shifts, detuning via a stigmator, using beam deflectors to probe different parts of the generalized pupil function characterizing the electro optical column, etc.

In some embodiments, higher order aberrations may be used in a phase diversity analysis (e.g., astigmatism). In some cases, higher order aberrations or additional types of phase diversities may not be preferred since they may involve solving for more unknown variables, thereby increasing computational load, increasing throughput, and reducing precision of generating a corrected image. In some embodiments, these constraints may be reduced by increasing the number of images obtained from an area in the FOV.

The described embodiments advantageously generate an image of a sample (e.g., for inspection) by obtaining images within a FOV without obtaining images outside of the FOV (e.g., in area 420 of FIG. 4), thereby increasing throughput.

In some embodiments, the above-described methods may be performed for a plurality of areas (e.g., areas 411 and 412 of FIG. 4) within a FOV. For example, a first phase diversity analysis may be performed for a first set of images associated with a first area (e.g., area 411 of FIG. 4) of a sample in the FOV. A second phase diversity analysis may be performed for a second set of images associated with a second area (e.g., area 412 of FIG. 4) of the sample in the FOV, where the first area may be different (e.g., a separate area) from the second area. In some embodiments, an adjustment of an inspection setting (e.g., using different voltage values or different current values, a range of voltage values, etc.) for the first area may be the same adjustment of an inspection setting for the second area (e.g., the voltage values used for obtaining images from the first area are the same as the voltage values used for obtaining images from the second area). It should be understood that using the same adjustment of an inspection setting for different areas does not necessarily mean that the obtained images for both areas will have the same associated focus-related values. In some embodiments, an adjustment of an inspection setting for the first area may be different from the adjustment of an inspection setting of the second area (e.g., one or more of the voltage values used for obtaining images from the first area is different from one or more of the voltage values used for obtaining images from the second area).

In some embodiments, performing phase diversity analyses to generate images for different areas of a sample may increase the accuracy of the calculations by performing local calculations instead of applying the same inspection settings (e.g., objective lens strength) across an entire FOV, thereby increasing the quality of the generated images. For example, to generate higher quality images of a sample in a FOV, the voltage setting used on the objective lens may vary depending on the area in the FOV that is being inspected. That is, the above-described methods may be performed for one or more areas within a FOV so that a focus-corrected image that is local to (e.g., specific to) the area may be generated. This method may be advantageous over a method that uses the same inspection settings (e.g., objective lens voltage) over the entire FOV to generate images. Additionally, the determination of the focus value for each area may provide valuable diagnostic data to improve the control or design of the imaging system.

This method may advantageously increase the image quality of a generated image (e.g., image 454 of FIG. 4) since focus-corrected images of an area may be generated by obtaining images of the same area, rather than depending on focus measurements performed outside of the FOV.

By generating a focus-corrected image of a sample area within the FOV using images obtained from within the FOV, this method may advantageously increase the image quality of the generated image by counteracting focus deviations that may occur over a sample (e.g., the field curvature may vary across a FOV). For example, the focus of an electron beam may change as the electron beam moves further away from the optical axis (e.g., the center of the FOV).

For example, a first area (e.g., area 411 of FIG. 4) of a sample may be located near the center of the FOV and a second area (e.g., area 412 of FIG. 4) of the sample may be located away from the center of the FOV. A first phase diversity analysis may be performed to generate an inspection image of the first area using images obtained from the first area. A second phase diversity analysis may be performed to generate an inspection image of the second area using images obtained from the second area. The disclosed embodiments include generation of images that overcome the constraints of focus deviations over a FOV of a sample.

In some embodiments, one or more obtained images may include noise that reduces the accuracy of the calculated defocus values or the accuracy of the maximum likelihood estimate, thereby reducing the quality of the generated one or more images. In some embodiments, due to the low dosage electron beam(s) (e.g., low number of nominal incident primary electrons per pixel) used to obtain an image of an area, the noise in the obtained images may be modeled by a Poisson distribution. The obtained images may be denoised, for example, using a method such as methods used in Zhang et al., “Modified phase diversity technique to eliminate Poisson noise for reconstructing high-resolution images”, Proc. SPIE 10838, 2019 Jan. 16. The residual noise in the images may be characterized by a Gaussian distribution.

In some embodiments, processor 322 may use a phase diversity analysis to determine a defocus value associated with each denoised image of the plurality of denoised images and a maximum likelihood estimate of the plurality of denoised images. The phase diversity analysis may be performed consistent with the disclosed embodiments.

By denoising the obtained images modeled after a Poisson distribution and characterizing the residual noise in the images following a Gaussian distribution, this method may advantageously reduce the computational load required during a phase diversity analysis, thereby resulting in higher quality images and increasing throughput. The phase diversity analysis may be performed on the denoised images using a method such as methods used in Zhang et al., “Modified phase diversity technique to eliminate Poisson noise for reconstructing high-resolution images”, Proc. SPIE 10838, 2019 Jan. 16. This method may be applied without denoising in the low dosage case

Reference is now made to FIG. 4, a schematic diagram illustrating an exemplary sample 400 and an image generation schematic 450, consistent with embodiments of the present disclosure.

As described above, an inspection system (e.g., inspection system 310 of FIG. 3) may obtain a plurality of images 452 of an area 411 of a sample (e.g., sample 208 of FIG. 2). Each obtained image of plurality of images 452 may have a different focus-related value (e.g., defocus value) due to an adjustment of an inspection setting during image acquisition. For example, the adjusted inspection setting may be a strength of the objective lens (e.g., using different voltage values). In some embodiments, the objective lens may be adjusted before each image of area 411 of a FOV 410 is obtained such that each image has a different defocus value. In some embodiments, the adjusted inspection setting may be a range of strength of the objective lens (e.g., a range of voltage values). Each image of plurality of images 452 may be obtained from the same area 411 of a sample in FOV 420.

As described above, an image generation component (e.g., image generation component 320 of FIG. 3) may include a processor (e.g., process 322 of FIG. 3) configured to use a phase diversity analysis to determine a defocus value associated with each image of plurality of images 452 and a maximum likelihood estimate of plurality of images 452.

A maximum likelihood estimate of plurality of images 452 may be obtained from the defocused images and their associated defocus values using phase diversity analysis. In some embodiments, the maximum likelihood estimate may be a final, focus-adjusted (e.g., focus-corrected) image 454 of area 411 within FOV 410. The maximum likelihood estimate may be obtained regardless of whether the defocus values correspond to the true unknown defocus value since the defocus distance between the images may be known. The phase diversity analysis allows for simultaneous determination of the maximum likelihood estimate as well as the true unknown defocus value. The image generation component may advantageously use a phase diversity analysis with a non-iterative approach to maximize the objective function since it solves for a single unknown variable (e.g., defocus value of an image), thereby increasing throughput of inspection.

The described embodiments advantageously generate image 454 of sample 400 (e.g., for inspection) by obtaining images 452 within FOV 410 without obtaining images from an area 420 outside of FOV 410, thereby increasing throughput.

In some embodiments, the above-described methods may be performed for a plurality of areas 411 and 412 within FOV 410. For example, a first phase diversity analysis may be performed for a first set of images associated with first area 411 of sample 400 in FOV 420. A second phase diversity analysis may be performed for a second set of images associated with second area 412 of sample 400 in FOV 410, where first area 411 may be different (e.g., a separate area) from second area 412.

In some embodiments, performing phase diversity analyses to generate images for different areas of a sample may increase the accuracy of the calculations by performing local calculations instead of applying the same inspection settings (e.g., objective lens strength) across an entire FOV 410, thereby increasing the quality of the generated images. For example, to generate higher quality images of sample 400 in FOV 410, the voltage setting used on the objective lens may vary depending on the area in FOV 410 that is being inspected. That is, the above-described methods may be performed for one or more areas within FOV 410 so that a focus-corrected image that is local to (e.g., specific to) the area may be generated. This method may be advantageous over a method that uses the same inspection settings (e.g., objective lens voltage) over the entire FOV 410 to generate images. For example, this method may use a first inspection setting to obtain images and generate a focus-corrected image of area 411 and a second inspection setting to obtain images and generate a focus-corrected image of area 412, as opposed to using the same inspection settings for areas 411 and 412 without performing separate analyses on both areas. Additionally, the determination of the focus value for each area may provide valuable diagnostic data to improve the control or design of the imaging system.

This method may advantageously increase the image quality of a generated image (e.g., image 454 of FIG. 4) since focus-corrected images of an area may be generated by obtaining images of the same area, rather than depending on focus measurements performed in area 420 outside of FOV 410.

By generating a focus-corrected image of a sample area within FOV 410 using images obtained from within FOV 410, this method may advantageously increase the image quality of the generated image by counteracting focus deviations that may occur over a sample (e.g., the field curvature may vary across a FOV). For example, the focus of an electron beam over area 411 may be different from the focus of an electron beam over area 412.

For example, area 411 of sample 400 may be located near the center of FOV 410 and area 412 of sample 400 may be located away from the center of FOV 410. A first phase diversity analysis may be performed to generate an inspection image of area 411 using images obtained from area 411. A second phase diversity analysis may be performed to generate an inspection image of area 412 using images obtained from area 412. The disclosed embodiments include generation of images that overcome the constraints of focus deviations over a FOV of a sample. In some embodiments, a single beam may be used to obtain images from one or more areas of the sample within the FOV. In some embodiments, two or more areas of the sample within the FOV may be scanned by different beams.

In some embodiments, one or more obtained images 452 may include noise that reduces the accuracy of the calculated defocus values or the accuracy of the maximum likelihood estimate, thereby reducing the quality of generated one or more images 454. In some embodiments, due to the low dosage electron beam(s) (e.g., low number of nominal incident primary electrons per pixel) used to obtain an image of an area, the noise in the obtained images may be modeled by a Poisson distribution. The obtained images 452 may be denoised, for example, using a method such as methods used in Zhang et al., “Modified phase diversity technique to eliminate Poisson noise for reconstructing high-resolution images”, Proc. SPIE 10838, 2019 Jan. 16. The residual noise in the images may be characterized by a Gaussian distribution.

In some embodiments, a processor may use a phase diversity analysis to determine a defocus value associated with each denoised image of the plurality of denoised images 452 and a maximum likelihood estimate of the plurality of denoised images 452. The phase diversity analysis may be performed consistent with the disclosed embodiments.

By denoising the obtained images 452 modeled after a Poisson distribution and characterizing the residual noise in images 452 following a Gaussian distribution, this method may advantageously reduce the computational load required during a phase diversity analysis, thereby resulting in higher quality images 454 and increasing throughput. The phase diversity analysis may be performed on the denoised images 452 using a method such as methods used in Zhang et al., “Modified phase diversity technique to eliminate Poisson noise for reconstructing high-resolution images”, Proc. SPIE 10838, 2019 Jan. 16. This method may be applied without denoising in the low dosage case.

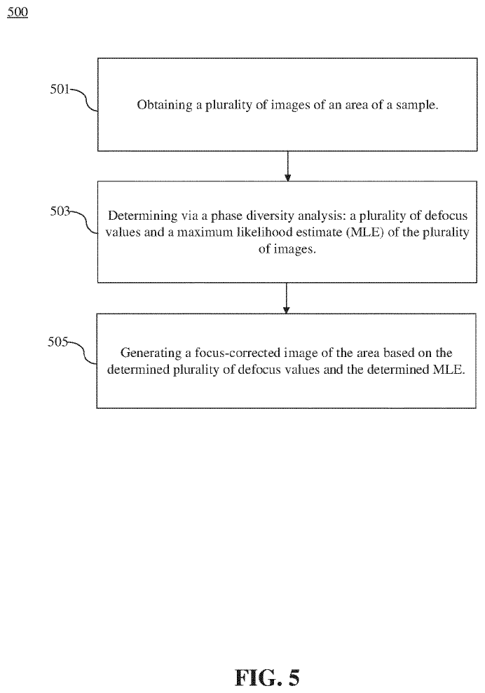

Reference is now made to FIG. 5, a flowchart illustrating an exemplary process 500 of improving image quality, consistent with embodiments of the present disclosure. The steps of method 500 can be performed by a system (e.g., system 300 of FIG. 3) executing on or otherwise using the features of a computing device, e.g., controller 109 of FIG. 1 for purposes of illustration. It is appreciated that the illustrated method 500 can be altered to modify the order of steps and to include additional steps.

At step 501, the system (e.g., using inspection system 310 of FIG. 3) may obtain a plurality of images e.g., images 452 of FIG. 4) of an area (e.g., areas 411 or 412 of FIG. 4) of a sample (e.g., sample 208 of FIG. 2 or sample 400 of FIG. 4). Each obtained image of the plurality of images may have a different focus-related value (e.g., defocus value) due to an adjustment of an inspection setting during image acquisition. For example, the adjusted inspection setting may be a strength of the objective lens (e.g., using different voltage values). In some embodiments, the objective lens (e.g., objective lens 231 of FIG. 2) may be adjusted before each image of an area of a FOV (e.g., FOV 410 of FIG. 4) is obtained such that each image has a different defocus value. In some embodiments, the adjusted inspection setting may be a range of strength of the objective lens (e.g., a range of voltage values). Each image of the plurality of images may be obtained from the same area of a sample in a FOV.

At step 503, a processor (e.g., processor 322 of FIG. 3) may be configured to use a phase diversity analysis to determine a defocus value associated with each image of the plurality of images received from the inspection system and a maximum likelihood estimate of the plurality of images.

A phase diversity analysis involves using multiple images of the same area, where a phase diversity (e.g., an aberration, a defocused electron beam, etc.) may be introduced to the area before each image of the multiple images is obtained. For example, a phase diversity may be introduced to the area before each image is obtained by adjusting the strength of the objective lens before obtaining each image. By controlling the phase diversity that is introduced to the area, processor 322 may maximize an objective function and solve for the unknown variables (e.g., defocus value of an image). A maximum likelihood estimate of the plurality of images may be obtained from the defocus values associated with each image using the phase diversity analysis.

In some embodiments, other types of phase diversity may be used in the phase diversity analysis. For example, phase diversity types that may be used in addition to, or in place of, a defocus value include aperture shifts, detuning via a stigmator, using beam deflectors to probe different parts of the generalized pupil function characterizing the electro optical column, etc.

In some embodiments, higher order aberrations may be used in a phase diversity analysis (e.g., astigmatism). In some cases, higher order aberrations or additional types of phase diversities may not be preferred since they may involve solving for more unknown variables, thereby increasing computational load, increasing throughput, and reducing precision of generating a corrected image. In some embodiments, these constraints may be reduced by increasing the number of images obtained from an area in the FOV.

At step 505, a processor may generate a focus-adjusted (e.g., focus-corrected) image (e.g., image 454 of FIG. 4) of the area based on the determined plurality of defocus values and the determined maximum likelihood estimate. In some embodiments, the maximum likelihood estimate may be a final, focus-corrected image (e.g., image 454 of FIG. 4) of an area within the FOV. The maximum likelihood estimate may be obtained regardless of whether the defocus values correspond to the true unknown defocus value since the defocus distance between the images may be known. The phase diversity analysis allows for simultaneous determination of the maximum likelihood estimate as well as the true unknown defocus value. The processor advantageously uses a phase diversity analysis with a non-iterative approach to maximize the objective function since it solves for a single unknown variable (e.g., defocus value of an image), thereby increasing throughput of inspection.

The described embodiments advantageously generate an image of a sample (e.g., for inspection) by obtaining images with a FOV without obtaining images outside of the FOV (e.g., in an area 420 outside of the FOV of FIG. 4), thereby increasing throughput.

In some embodiments, the above-described methods may be performed for a plurality of areas (e.g., areas 411 and 412 of FIG. 4) within a FOV. For example, a first phase diversity analysis may be performed for a first set of images associated with a first area (e.g., area 411 of FIG. 4) of a sample in the FOV. A second phase diversity analysis may be performed for a second set of images associated with a second area (e.g., area 412 of FIG. 4) of the sample in the FOV, where the first area may be different (e.g., a separate area) from the second area.

In some embodiments, performing phase diversity analyses to generate images for different areas of a sample may increase the accuracy of the calculations by performing local calculations instead of applying the same inspection settings (e.g., objective lens strength) across an entire FOV, thereby increasing the quality of the generated images. For example, to generate higher quality images of a sample in a FOV, the voltage setting used on the objective lens may vary depending on the area in the FOV that is being inspected. That is, the above-described methods may be performed for one or more areas within a FOV so that a focus-corrected image that is local to (e.g., specific to) the area may be generated. This method may be advantageous over a method that uses the same inspection settings (e.g., objective lens voltage) over the entire FOV to generate images. Additionally, the determination of the focus value for each area may provide valuable diagnostic data to improve the control or design of the imaging system.

This method may advantageously increase the image quality of a generated image since focus-corrected images of an area may be generated by obtaining images of the same area, rather than depending on focus measurements performed outside of the FOV.

By generating a focus-corrected image of a sample area within the FOV using images obtained from within the FOV, this method may advantageously increase the image quality of the generated image by counteracting focus deviations that may occur over a sample (e.g., the field curvature may vary across a FOV). For example, the focus of an electron beam may change as the electron beam moves further away from the optical axis (e.g., the center of the FOV).

For example, a first area (e.g., area 411 of FIG. 4) of a sample may be located near the center of the FOV and a second area (e.g., area 412 of FIG. 4) of the sample may be located away from the center of the FOV. A first phase diversity analysis may be performed to generate an inspection image of the first area using images obtained from the first area. A second phase diversity analysis may be performed to generate an inspection image of the second area using images obtained from the second area. The disclosed embodiments include generation of images that overcome the constraints of focus deviations over a FOV of a sample.

In some embodiments, one or more obtained images may include noise that reduces the accuracy of the calculated defocus values or the accuracy of the maximum likelihood estimate, thereby reducing the quality of the generated one or more images. In some embodiments, due to the low dosage electron beam(s) (e.g., low number of nominal incident primary electrons per pixel) used to obtain an image of an area, the noise in the obtained images may be modeled by a Poisson distribution. The obtained images may be denoised, for example, using a method such as methods used in Zhang et al., “Modified phase diversity technique to eliminate Poisson noise for reconstructing high-resolution images”, Proc. SPIE 10838, 2019 Jan. 16. The residual noise in the images may be characterized by a Gaussian distribution.

In some embodiments, a processor may use a phase diversity analysis to determine a defocus value associated with each denoised image of the plurality of denoised images and a maximum likelihood estimate of the plurality of denoised images. The phase diversity analysis may be performed consistent with the disclosed embodiments.

By denoising the obtained images modeled after a Poisson distribution and characterizing the residual noise in the images following a Gaussian distribution, this method may advantageously reduce the computational load required during a phase diversity analysis, thereby resulting in higher quality images and increasing throughput. The phase diversity analysis may be performed on the denoised images using a method such as methods used in Zhang et al., “Modified phase diversity technique to eliminate Poisson noise for reconstructing high-resolution images”, Proc. SPIE 10838, 2019 Jan. 16. This method may be applied without denoising in the low dosage case.

A non-transitory computer readable medium may be provided that stores instructions for a processor of a controller (e.g., controller 109 of FIG. 1) for controlling the electron beam tool, controlling the voltages applies to the objective lens (e.g., objective lens 231 of FIG. 2), or controlling processors (e.g., processor 322 of FIG. 3) of other systems and servers, consistent with embodiments in the present disclosure. These instructions may allow the one or more processors to carry out image processing, data processing, beamlet scanning, database management, graphical display, operations of a charged particle beam apparatus, or another imaging device, or the like. In some embodiments, the non-transitory computer readable medium may be provided that stores instructions for a processor to perform the steps of process 500. Common forms of non-transitory media include, for example, a floppy disk, a flexible disk, hard disk, solid state drive, magnetic tape, or any other magnetic data storage medium, a Compact Disc Read Only Memory (CD-ROM), any other optical data storage medium, any physical medium with patterns of holes, a Random Access Memory (RAM), a Programmable Read Only Memory (PROM), and Erasable Programmable Read Only Memory (EPROM), a FLASH-EPROM or any other flash memory, Non-Volatile Random Access Memory (NVRAM), a cache, a register, any other memory chip or cartridge, and networked versions of the same.

The embodiments may further be described using the following clauses:
1. A method of improving image quality, the method comprising: obtaining a plurality of images of an area of a sample; determining via a phase diversity analysis: a plurality of focus-related values, wherein each focus-related value of the plurality of focus-related values is associated with each image of the plurality of images; a maximum likelihood estimate (MLE) of the plurality of images; and generating a focus-corrected image of the area based on the determined plurality of focus-related values and the determined MLE.
2. The method of clause 1, wherein each focus-related value of the plurality of focus-related values comprises a defocus value.
3. The method of any one of clauses 1-2, wherein each image of the plurality of images has a different associated focus-related value.
4. The method of any one of clauses 1-3, wherein the plurality of focus-related values comprise a range of focus-related values.
5. The method of any one of clauses 1-4, wherein the range of focus-related values corresponds to a range of voltages associated with an objective lens.
6. The method of any one of clauses 1-5, wherein the area is within a field of view of the sample.
7. The method of any one of clauses 1-6, wherein the MLE is determined based on the determined plurality of focus-related values.
8. The method of any one of clauses 1-7, wherein:
the area comprises a first area of the sample and a second area of the sample;
the plurality of images comprises a first set of images of the first area of the sample and a second set of images of the second area of the sample; the phase diversity analysis comprises a first phase diversity analysis corresponding to the first set of images and a second phase diversity analysis corresponding to the second set of images; the plurality of focus-related values comprises a first set of focus-related values corresponding to the first phase diversity analysis and a second set of focus-related values corresponding to the second phase diversity analysis;
the MLE comprises a first MLE of the first set of images and a second MLE of the second set of images;
and the focus-corrected image comprises a first focus-corrected image of the first area and a second focus-corrected image of the second area.
9. The method of clause 8, further comprising: determining, via the first phase diversity analysis: the first set of focus-related values, wherein each focus-related value of the first set of focus-related values is associated with each image of the first set of images; the first MLE of the first set of images;
and generating the first focus-corrected image of the first area based on the determined first plurality of focus-related values and the determined first MLE.
10. The method of any one of clauses 8-9, further comprising: determining, via the second phase diversity analysis: the second set of focus-related values, wherein each focus-related value of the second set of focus-related values is associated with each image of the second set of images; the second MLE of the second set of images; and generating the second focus-corrected image of the second area based on the determined second plurality of focus-related values and the determined second MLE.
11. The method of any one of clauses 1-10, further comprising: denoising noise in the obtained plurality of images, wherein the noise is modeled as a Poisson distribution; and modeling the denoised noise in the obtained plurality of images on a Gaussian distribution.
12. The method of clause 11, wherein each focus-related value of the plurality of focus-related values is associated with each denoised image of the plurality of images modeled on the Gaussian distribution.
13. A method of improving image quality, the method comprising: obtaining a plurality of images of an area of a sample; determining via a phase diversity analysis: a plurality of focus-related values, wherein each focus-related value of the plurality of focus-related values is associated with each image of the plurality of images; a maximum likelihood estimate (MLE) of the plurality of images; and generating a focus-adjusted image of the area based on the determined plurality of focus-related values and the determined MLE.
14. A method of improving image quality, the method comprising: obtaining a plurality of images of an area in a field of view of a sample, wherein a first image of the plurality of images has a first focus-related value and a second image of the plurality of images has a second focus-related value that is different from the first focus-related value; and generating a focus-adjusted image of the area in the field of view using the first and second images.
15. The method of clause 14, wherein generating the focus-adjusted image of the area in the field of view comprises: performing a phase diversity analysis of the first and second images; and determining a maximum likelihood estimate of the first and second images.
16. The method of any one of clauses 14-15, wherein the first focus-related value corresponds to a first voltage associated with an objective lens and the second focus-related value corresponds to a second voltage associated with the objective lens.
17. The method of any one of clauses 14-16, further comprising:

denoising noise in the first image and the second image, wherein the noise is modeled as a Poisson distribution; and modeling the denoised noise in the first image and the second image on a Gaussian distribution.
18. The method of clause 17, wherein the first focus-related value is associated with the first denoised image and the second focus-related value is associated with the second denoised image.
19. A system for improving image quality, the system comprising: a controller including circuitry configured to cause the system to perform:
obtaining a plurality of images of an area of a sample; determining via a phase diversity analysis:
a plurality of focus-related values, wherein each focus-related value of the plurality of focus-related values is associated with each image of the plurality of images; a maximum likelihood estimate (MLE) of the plurality of images; and generating a focus-corrected image of the area based on the determined plurality of focus-related values and the determined MLE.
20. The system of clause 19, wherein each focus-related value of the plurality of focus-related values comprises a defocus value.
21. The system of any one of clauses 19-20, wherein each image of the plurality of images has a different associated focus-related value.
22. The system of any one of clauses 19-21, wherein the plurality of focus-related values comprise a range of focus-related values.
23. The system of any one of clauses 19-22, wherein the range of focus-related values corresponds to a range of voltages associated with an objective lens.
24. The system of any one of clauses 19-23, wherein the area is within a field of view of the sample.
25. The system of any one of clauses 19-24, wherein the MLE is determined based on the determined plurality of focus-related values.
26. The system of any one of clauses 19-25, wherein: the area comprises a first area of the sample and a second area of the sample; the plurality of images comprises a first set of images of the first area of the sample and a second set of images of the second area of the sample; the phase diversity analysis comprises a first phase diversity analysis corresponding to the first set of images and a second phase diversity analysis corresponding to the second set of images; the plurality of focus-related values comprises a first set of focus-related values corresponding to the first phase diversity analysis and a second set of focus-related values corresponding to the second phase diversity analysis; the MLE comprises a first MLE of the first set of images and a second MLE of the second set of images; and the focus-corrected image comprises a first focus-corrected image of the first area and a second focus-corrected image of the second area.
27. The system of clause 26, wherein the circuitry is configured to cause the system to further perform: determining, via the first phase diversity analysis: the first set of focus-related values, wherein each focus-related value of the first set of focus-related values is associated with each image of the first set of images; the first MLE of the first set of images; and generating the first focus-corrected image of the first area based on the determined first plurality of focus-related values and the determined first MLE.
28. The system of any one of clauses 26-27, wherein the circuitry is configured to cause the system to further perform: determining, via the second phase diversity analysis: the second set of focus-related values, wherein each focus-related value of the second set of focus-related values is associated with each image of the second set of images; the second MLE of the second set of images; and generating the second focus-corrected image of the second area based on the determined second plurality of focus-related values and the determined second MLE.
29. The system of any one of clauses 19-28, wherein the circuitry is configured to cause the system to further perform: denoising noise in the obtained plurality of images, wherein the noise is modeled as a Poisson distribution; and modeling the denoised noise in the obtained plurality of images on a Gaussian distribution.
30. The system of clause 29, wherein each focus-related value of the plurality of focus-related values is associated with each denoised image of the plurality of images modeled on the Gaussian distribution.
31. A system for improving image quality, the system comprising: a controller including circuitry configured to cause the system to perform: obtaining a plurality of images of an area of a sample; determining via a phase diversity analysis: a plurality of focus-related values, wherein each focus-related value of the plurality of focus-related values is associated with each image of the plurality of images; a maximum likelihood estimate (MLE) of the plurality of images; and generating a focus-adjusted image of the area based on the determined plurality of focus-related values and the determined MLE.
32. A system for improving image quality, the system comprising: a controller including circuitry configured to cause the system to perform: obtaining a plurality of images of an area in a field of view of a sample, wherein a first image of the plurality of images has a first focus-related value and a second image of the plurality of images has a second focus-related value that is different from the first focus-related value; and generating a focus-adjusted image of the area in the field of view using the first and second images.
33. The system of clause 32, wherein generating the focus-adjusted image of the area in the field of view comprises: performing a phase diversity analysis of the first and second images; and determining a maximum likelihood estimate of the first and second images.
34. The system of any one of clauses 32-33, wherein the first focus-related value corresponds to a first voltage associated with an objective lens and the second focus-related value corresponds to a second voltage associated with the objective lens.
35. The system of any one of clauses 32-34, wherein the circuitry is configured to cause the system to further perform: denoising noise in the first image and the second image, wherein the noise is modeled as a Poisson distribution; and modeling the denoised noise in the first image and the second image on a Gaussian distribution.
36. The system of clause 35, wherein the first focus-related value is associated with the first denoised image and the second focus-related value is associated with the second denoised image.
37. A non-transitory computer readable medium that stores a set of instructions that is executable by at least one processor of a computing device to cause the computing device to perform a method for improving image quality, the method comprising: obtaining a plurality of images of an area of a sample; determining via a phase diversity analysis: a plurality of focus-related values, wherein each focus-related value of the plurality of focus-related values is associated with each image of the plurality of images; a maximum likelihood estimate (MLE) of the plurality of images; and
generating a focus-corrected image of the area based on the determined plurality of focus-related values and the determined MLE.
38. The non-transitory computer readable medium of clause 37, wherein each focus-related value of the plurality of focus-related values comprises a defocus value.
39. The non-transitory computer readable medium of any one of clauses 37-38, wherein each image of the plurality of images has a different associated focus-related value.
40. The non-transitory computer readable medium of any one of clauses 37-39, wherein the plurality of focus-related values comprise a range of focus-related values.
41. The non-transitory computer readable medium of any one of clauses 37-40, wherein the range of focus-related values corresponds to a range of voltages associated with an objective lens.
42. The non-transitory computer readable medium of any one of clauses 37-41, wherein the area is within a field of view of the sample.
43. The non-transitory computer readable medium of any one of clauses 37-42, wherein the MLE is determined based on the determined plurality of focus-related values.
44. The non-transitory computer readable medium of any one of clauses 37-43, wherein:
the area comprises a first area of the sample and a second area of the sample;
the plurality of images comprises a first set of images of the first area of the sample and a second set of images of the second area of the sample; the phase diversity analysis comprises a first phase diversity analysis corresponding to the first set of images and a second phase diversity analysis corresponding to the second set of images; the plurality of focus-related values comprises a first set of focus-related values corresponding to the first phase diversity analysis and a second set of focus-related values corresponding to the second phase diversity analysis; the MLE comprises a first MLE of the first set of images and a second MLE of the second set of images; and the focus-corrected image comprises a first focus-corrected image of the first area and a second focus-corrected image of the second area.
45. The non-transitory computer readable medium of clause 44, wherein the set of instructions that is executable by at least one processor of a computing device to cause the computing device to further perform: determining, via the first phase diversity analysis: the first set of focus-related values, wherein each focus-related value of the first set of focus-related values is associated with each image of the first set of images; the first MLE of the first set of images; and
generating the first focus-corrected image of the first area based on the determined first plurality of focus-related values and the determined first MLE.
46. The non-transitory computer readable medium of any one of clauses 44-45, wherein the set of instructions that is executable by at least one processor of a computing device to cause the computing device to further perform: determining, via the second phase diversity analysis: the second set of focus-related values, wherein each focus-related value of the second set of focus-related values is associated with each image of the second set of images; the second MLE of the second set of images; and generating the second focus-corrected image of the second area based on the determined second plurality of focus-related values and the determined second MLE.
47. The non-transitory computer readable medium of any one of clauses 37-46, wherein the set of instructions that is executable by at least one processor of a computing device to cause the computing device to further perform: denoising noise in the obtained plurality of images, wherein the noise is modeled as a Poisson distribution; and modeling the denoised noise in the obtained plurality of images on a Gaussian distribution.
48. The non-transitory computer readable medium of clause 47, wherein each focus-related value of the plurality of focus-related values is associated with each denoised image of the plurality of images modeled on the Gaussian distribution.
49. A non-transitory computer readable medium that stores a set of instructions that is executable by at least one processor of a computing device to cause the computing device to perform a method for improving image quality, the method comprising: obtaining a plurality of images of an area of a sample; determining via a phase diversity analysis: a plurality of focus-related values, wherein each focus-related value of the plurality of focus-related values is associated with each image of the plurality of images; a maximum likelihood estimate (MLE) of the plurality of images; and generating a focus-adjusted image of the area based on the determined plurality of focus-related values and the determined MLE.
50. A non-transitory computer readable medium that stores a set of instructions that is executable by at least one processor of a computing device to cause the computing device to perform a method for improving image quality, the method comprising: obtaining a plurality of images of an area in a field of view of a sample, wherein a first image of the plurality of images has a first focus-related value and a second image of the plurality of images has a second focus-related value that is different from the first focus-related value; and generating a focus-adjusted image of the area in the field of view using the first and second images.
51. The non-transitory computer readable medium of clause 50, wherein generating the focus-adjusted image of the area in the field of view comprises: performing a phase diversity analysis of the first and second images; and determining a maximum likelihood estimate of the first and second images.
52. The non-transitory computer readable medium of any one of clauses 50-51, wherein the first focus-related value corresponds to a first voltage associated with an objective lens and the second focus-related value corresponds to a second voltage associated with the objective lens.
53. The non-transitory computer readable medium of any one of clauses 50-52, wherein the set of instructions that is executable by at least one processor of a computing device to cause the computing device to further perform: denoising noise in the first image and the second image, wherein the noise is modeled as a Poisson distribution; and modeling the denoised noise in the first image and the second image on a Gaussian distribution.
54. The non-transitory computer readable medium of clause 53, wherein the first focus-related value is associated with the first denoised image and the second focus-related value is associated with the second denoised image.

It will be appreciated that the embodiments of the present disclosure are not limited to the exact construction that has been described above and illustrated in the accompanying drawings, and that various modifications and changes may be made without departing from the scope thereof.

1. A system for improving image quality, the system comprising:
a controller including circuitry configured to cause the system to perform:
obtaining a plurality of images of an area of a sample;
determining via a phase diversity analysis:
a plurality of focus-related values, wherein each focus-related value of the plurality of focus-related values is associated with each image of the plurality of images;
a maximum likelihood estimate (MLE) of the plurality of images; and
generating a focus-corrected image of the area based on the determined plurality of focus-related values and the determined MLE.

2. The system of claim 1, wherein each focus-related value of the plurality of focus-related values comprises a defocus value.

3. The system of claim 1, wherein each image of the plurality of images has a different associated focus-related value.

4. The system of claim 1, wherein the plurality of focus-related values comprise a range of focus-related values.

5. The system of claim 1, wherein a range of the plurality of focus-related values corresponds to a range of voltages associated with an objective lens.

6. The system of claim 1, wherein the area is within a field of view of the sample.

7. The system of claim 1, wherein the MLE is determined based on the determined plurality of focus-related values.

8. The system of claim 1, wherein:
the area comprises a first area of the sample and a second area of the sample;
the plurality of images comprises a first set of images of the first area of the sample and a second set of images of the second area of the sample;
the phase diversity analysis comprises a first phase diversity analysis corresponding to the first set of images and a second phase diversity analysis corresponding to the second set of images;
the plurality of focus-related values comprises a first set of focus-related values corresponding to the first phase diversity analysis and a second set of focus-related values corresponding to the second phase diversity analysis;
the MLE comprises a first MLE of the first set of images and a second MLE of the second set of images; and
the focus-corrected image comprises a first focus-corrected image of the first area and a second focus-corrected image of the second area.

9. The system of claim 8, wherein the circuitry is configured to cause the system to further perform:
determining, via the first phase diversity analysis:
the first set of focus-related values, wherein each focus-related value of the first set of focus-related values is associated with each image of the first set of images;
the first MLE of the first set of images; and
generating the first focus-corrected image of the first area based on the determined first plurality of focus-related values and the determined first MLE.

10. The system of claim 8, wherein the circuitry is configured to cause the system to further perform:
determining, via the second phase diversity analysis:
the second set of focus-related values, wherein each focus-related value of the second set of focus-related values is associated with each image of the second set of images;
the second MLE of the second set of images; and
generating the second focus-corrected image of the second area based on the determined second plurality of focus-related values and the determined second MLE.

11. The system of claim 1, wherein the circuitry is configured to cause the system to further perform:
denoising noise in the obtained plurality of images, wherein the noise is modeled as a Poisson distribution; and
modeling the denoised noise in the obtained plurality of images on a Gaussian distribution.

12. The system of claim 11, wherein each focus-related value of the plurality of focus-related values is associated with each denoised image of the plurality of images modeled on the Gaussian distribution.

13. A method of improving image quality, the method comprising:
obtaining a plurality of images of an area of a sample;
determining via a phase diversity analysis:
a plurality of focus-related values, wherein each focus-related value of the plurality of focus-related values is associated with each image of the plurality of images;
a maximum likelihood estimate (MLE) of the plurality of images; and
generating a focus-corrected image of the area based on the determined plurality of focus-related values and the determined MLE.

14. The method of claim 13, wherein each focus-related value of the plurality of focus-related values comprises a defocus value.

15. The method of claim 13, wherein each image of the plurality of images has a different associated focus-related value.

16. The method of claim 13, wherein the plurality of focus-related values comprise a range of focus-related values.

17. The method of claim 13, wherein a range of the plurality of focus-related values corresponds to a range of voltages associated with an objective lens.

18. The method of claim 13, wherein the area is within a field of view of the sample.

19. The method of claim 13, wherein the MLE is determined based on the determined plurality of focus-related values.

20. A non-transitory computer readable medium that stores a set of instructions that is executable by at least one processor of a computing device to cause the computing device to perform operations for improving image quality, the operations comprising:
obtaining a plurality of images of an area of a sample;
determining via a phase diversity analysis:
a plurality of focus-related values, wherein each focus-related value of the plurality of focus-related values is associated with each image of the plurality of images;
a maximum likelihood estimate (MLE) of the plurality of images; and
generating a focus-corrected image of the area based on the determined plurality of focus-related values and the determined MLE.
